(19) United States
(12) Patent Application Publication
(10) Pub. No.: US 2026/0112009 A1
(43) Pub. Date: Apr. 23, 2026

(54) APPLYING IMAGE OVERLAYS ONTO HDR IMAGE

(71) Applicant: Lemon Inc., Grand Cayman (KY)

(72) Inventors: Daniel Elwell, Los Angeles, CA (US); He Qin, Los Angeles, CA (US); Zongcheng Chu, Los Angeles, CA (US); Wenqing Jiang, Los Angeles, CA (US)

(21) Appl. No.: 18/919,266

(22) Filed: Oct. 17, 2024

(51) Int. Cl. G06T 5/92; G06T 5/50; G06V 10/60

(52) U.S. Cl. CPC G06T 5/92; G06T 5/50; G06V 10/60; G06T 2207/20208; G06T 2207/20221

(57) ABSTRACT

A computing system is provided for applying image overlays onto a High Dynamic Range (HDR) image. The system receives the HDR image, generates a first gain map and a Standard Dynamic Range (SDR) image based on the received HDR image, renders at least one overlay image to generate an SDR effects image buffer and an effects gain map, overlays the effects gain map and the first gain map to generate a second gain map, overlays the SDR image and the SDR effects image buffer to generate an edited SDR image, generates an edited HDR image based on the edited SDR image and the second gain map, and generate an output based on the edited HDR image.

### BACKGROUND

Imaging technologies have evolved to significantly advance visual quality, particularly with the advent of High Dynamic Range (HDR) photos. HDR photos provide a greater range of luminosity and color depth compared to Standard Dynamic Range (SDR) photos. For example, HDR is characterized by brighter whites, darker blacks, and a wider potential number of visible colors, which result in more vivid and true-to-life images. This increased color depth and expanded dynamic range make HDR superior in delivering more immersive visual experiences, particularly when compared to SDR photos, which operates within a more limited color gamut and narrower range of brightness levels.

With the growing adoption of HDR-enabled cameras and displays, especially in mobile devices, modern smartphones, tablets, and cameras now commonly support HDR photos, bringing a professional-grade viewing experience to the consumer market.

However, the proliferation of HDR photography has also presented challenges when attempting to apply image overlay effects designed for SDR photos onto an HDR photo. Applications (apps) and software that were originally developed for SDR photos are often not optimized to handle the increased color depth and dynamic range of HDR content. For example, when images designed to be overlaid onto SDR photos are overlaid onto an HDR photo, the mismatch between the two formats can lead to severe color distortions. These distortions can manifest as oversaturation or desaturation in certain color spaces, resulting in an unnatural or undesirable appearance of the photo.

### SUMMARY

In view of the above, a computing system is provided for applying image overlays onto a High Dynamic Range (HDR) image. The computing system comprises processing circuitry and memory storing instructions that, when executed, cause the processing circuitry to receive an HDR image. Further, the processing circuitry is caused to generate a first gain map and a Standard Dynamic Range (SDR) image based on the received HDR image. Then the processing circuitry is caused to render at least one overlay image to generate an SDR effects image buffer and an effects gain map, overlay the effects gain map and the first gain map to generate a second gain map, overlay the SDR image and the SDR effects image buffer to generate an edited SDR image, generate an edited HDR image based on the edited SDR image and the second gain map, and generate an output based on the edited HDR image.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1 illustrates a schematic view of a computing system according to an example of the present disclosure.

FIG. 2 illustrates a schematic view of the operations of the tone mapping algorithm in the HDR-to-SDR pipeline of the computing system of FIG. 1.

FIG. 3 illustrates a schematic view of the operations of the gain map overlay module of the computing system of FIG. 1.

FIG. 4 illustrates a schematic view of the operations of the inverse tone mapping algorithm of the SDR-to-HDR pipeline of the computing system of FIG. 1.

FIG. 5 is a flow chart of a method for overlaying an SDR image and an SDR effects image buffer together according to an example embodiment of the present disclosure.

FIG. 6 is a flow chart of a method for overlaying an effects gain map and a first gain map together according to an example embodiment of the present disclosure.

FIG. 7 is a flow chart of a method for applying image overlays onto an HDR image according to an example embodiment of the present disclosure.

FIG. 8 shows an example computing environment of the present disclosure.

### DETAILED DESCRIPTION

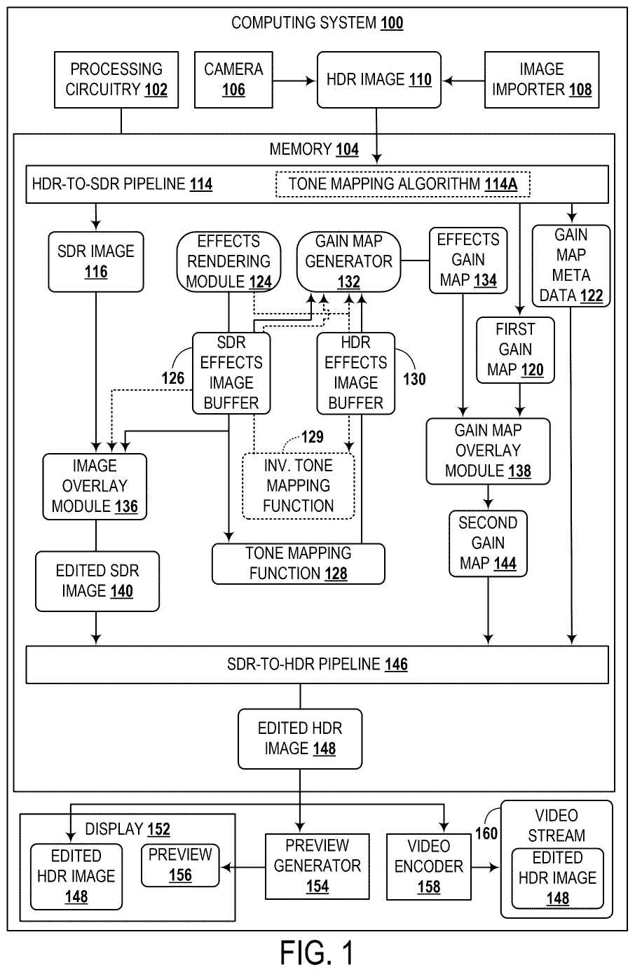

FIG. 1 shows a schematic view of an example computing system 100 for applying image overlays onto a High Dynamic Range (HDR) image 110. The example computing system 100 can be implemented with various types of computing devices, including mobile devices, smart phones, personal computers, laptops, computing servers, etc. The example computing system 100 includes processing circuitry 102 and memory 104 storing instructions that, during execution, causes the processing circuitry 102 to perform the various processes described herein to receive the HDR image 110 which comprises a plurality of pixels, each pixel having one or a plurality of brightness values for each of a plurality of color components. When the HDR image 110 is in a format that encodes a gain map, the processing circuitry 102 decodes the HDR image 110 into an SDR image 116 and a first gain map 120. When the HDR image 110 is in a format that does not encode a gain map, the processing circuitry 102 applies at least a tone mapping algorithm 114A to each pixel in the HDR image 110, thereby generating a first gain map 120 and a Standard Dynamic Range (SDR) image 116 with transformed brightness values for each of the plurality of color components. At least one overlay image is rendered to generate an SDR effects image buffer 126 and an effects gain map 134. The effects gain map 134 and the first gain map 120 are overlaid together to generate a second gain map 144. The SDR image 116 and the SDR effects image buffer 126 are overlaid together to generate an edited SDR image 140. An edited HDR image 148 is encoded based on the edited SDR image 140 and the second gain map 144, and an output is generated based on the edited HDR image 148. The generated edited HDR image 148, which include the applied image overlays, may be outputted for rendering on a display 152 and/or encoded by a video encoder 158 to generate and output a video stream 160 incorporating the edited HDR image 148. The display 152 may be a display device within the computing system 100 or an external device that is communicatively coupled to the computing system 100.

The computing system 100 further includes a camera 106 configured to capture the HDR image 110, which is subsequently transferred into the memory 104 for further processing by an HDR-to-SDR pipeline 114. The video data of the HDR image 110 may be initially processed by an image signal processor before being transferred to the memory 104. Alternatively, the HDR image 110 may be transferred directly into the memory 104 in real-time via a high-speed communication interface, such as Universal Serial Bus (USB), Thunderbolt, or high-definition multimedia interface (HDMI). The high-speed communication interface may implement wireless technology via Wi-Fi transmission, Bluetooth, wireless HDMI, or cellular networks, for example.

Alternatively, the HDR image 110 may be imported from various external sources by an image importer 108 and subsequently transferred into the memory 104. For example, the image importer 108 may be embodied as a capture hardware configured to capture HDR image 110 from external cameras and transfer the image data into the memory 104.

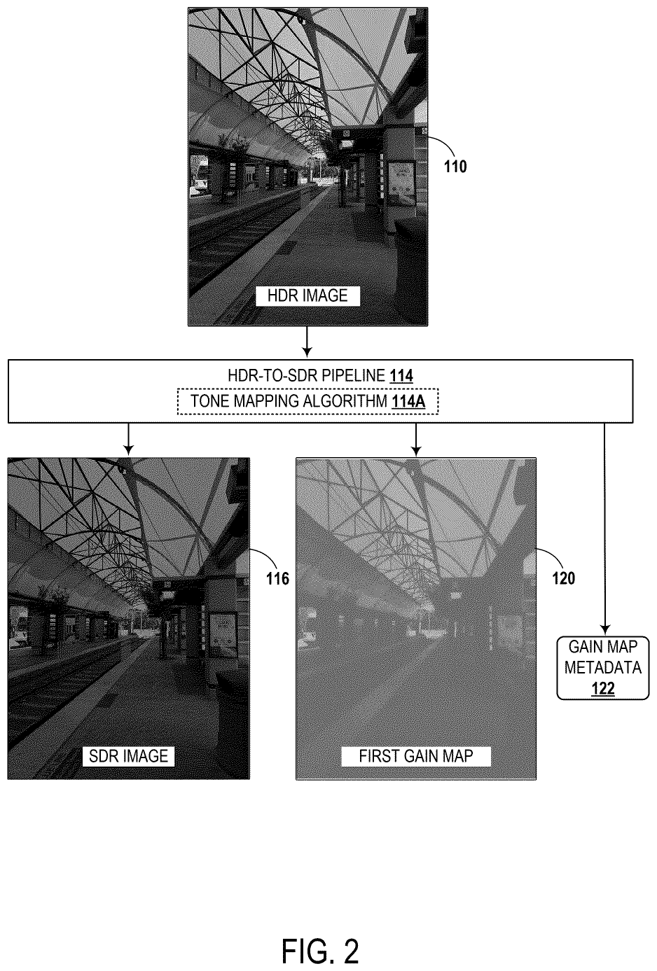

Turning to FIG. 2, the HDR-to-SDR pipeline 114 processes the HDR image 110 to generate an SDR image 116, a first gain map 120, and gain map metadata 122. The HDR image 110 comprises a plurality of pixels, each pixel having one or a plurality of brightness values for each color component. For example, the inputted HDR image 110 may have a wide-gamut Rec. 2020 color space with a color depth of 10 bits. The outputted SDR image 116 may have a narrow-gamut Rec. 709 color space with a color depth of 8 bits. Each pixel of the HDR image 110 is processed by the functions of the HDR-to-SDR pipeline 114 to generate the SDR image 116, a first gain map 120, and gain map metadata 122. The first gain map 120 encodes pixel data on the adjustment of brightness and contrast of the SDR image 116 in logarithmic space to convert the edited SDR image 140 to the HDR format. The gain map metadata 122 may describe attributes associated with the first gain map 120, including the dynamic range (maximum and minimum brightness values) and resolution of the original HDR image 110.

Returning to FIG. 1, the HDR-to-SDR pipeline 114 may include a tone mapping algorithm 114A which compresses the range of brightness values in the HDR image 110 to fit within the limits of the display 152 while preserving the visual details and contrast of the original HDR image 110 to the furthest extent possible within the physical limitations of the display 152. Other functions included in the HDR-to-SDR pipeline 114 may include an electro-optical transfer function and an opto-electric transfer function. The functions of the HDR-to-SDR pipeline 114 may be applied to each pixel in the HDR image 110 in real-time as the HDR image 110 is received from the camera 106, such that the generated SDR image 116 is outputted for rendering on the display 152 without perceptible delay.

The effects rendering module 124 is configured to render at least one overlay image to generate an SDR effects image buffer 126. Examples of overlay images include, but are not limited to, stickers, emojis, virtual props, text effects, face masks, two-dimensional or three-dimensional objects, and particle effects. These overlay images may be rendered onto an empty SDR effects image buffer 126, such that only the pixels that are directly affected by the effects are modified, and pixels where no effects are present remain fully transparent pixels. When the overlay images are images such as stickers and emojis, the boundaries of the images are smaller than the boundaries of the HDR image 110.

A tone mapping function 128 is subsequently applied to the SDR effects image buffer 126 to generate an HDR effects image buffer 130 containing the overlay images. The tone mapping function 128 is configured to determine an adjustment factor of a given pixel of the SDR effects image buffer 126 based on a peak luminance of the display 152, and scale each color component of the given pixel based on the adjustment factor. Examples of the tone mapping function 128 that can be used to generate the HDR effects image buffer 130 include a linear function, a logarithmic function, an exponential function, Reinhard's formula, and filmic tone mapping operators, such as the Hable Tone Mapping Operator or the Academy Color Encoding System (ACES).

A gain map generator 132 computes and generates an effects gain map 134 using the HDR effects image buffer 130 and the SDR effects image buffer 126. The effects gain map 134 specifies how to adjust pixel values of the visual effects when converting from SDR format to HDR format or vice versa. Similarly to the first gain map 120, the effects gain map 134 is expressed as a scalar function in logarithmic space, relative to a maximum content boost value and a minimum content boost value, to define transitions in brightness levels between the SDR format and the HDR format. The minimum content boost value defines how much darker the edited HDR image 148 can become relative to the edited SDR image 140. The maximum content boost value defines how much brighter the edited HDR image 148 can become relative to the edited SDR image 140.

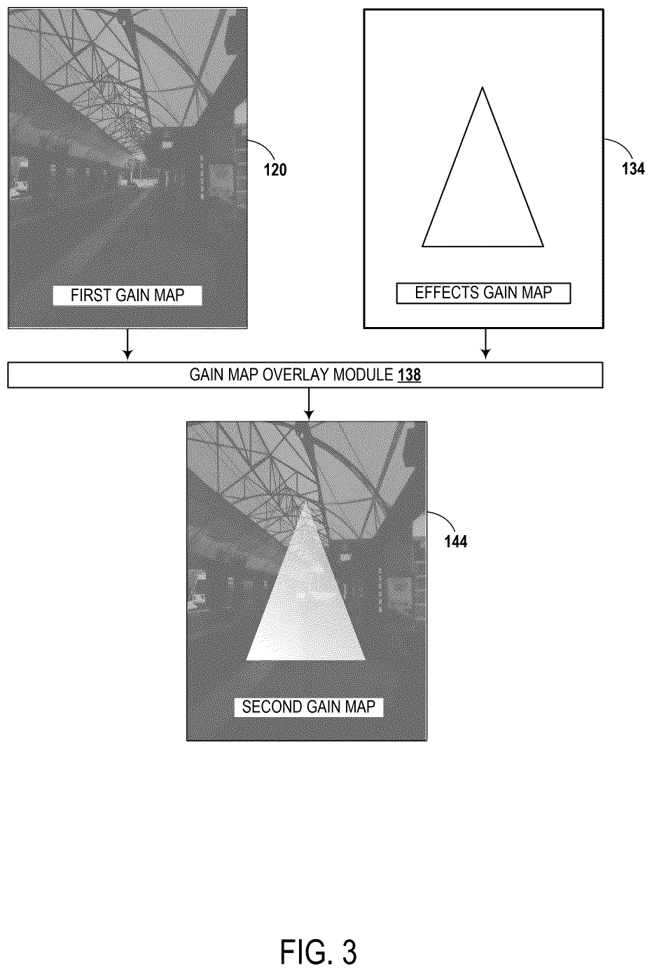

Turning to FIG. 3, the gain map overlay module 138 receives the effects gain map 134 and the first gain map 120, and overlays the gain maps 120, 134 together to encode a second gain map 144. When a given pixel of the effects gain map 134 is opaque, the given pixel of the effects gain map 134 becomes the given pixel of the second gain map 144. When the given pixel of the effects gain map 134 is fully transparent, a corresponding pixel of the first gain map 120 becomes the pixel of the second gain map 144. When the given pixel of the effects gain map 134 is semi-transparent, the gain map overlay module 138 fits the alpha value of the given pixel of the effects gain map 134 to a logarithmic curve, and performs standard linear alpha blending on the given pixel of the effects gain map 134 to generate the given pixel of the second gain map 144.

Returning to FIG. 1, the image overlay module 136 overlays the SDR image 116 and the SDR effects image buffer 126 together to generate an edited SDR image 140 with an edited SDR image 140. When a given pixel of the SDR effects image buffer 126 is opaque, the given pixel of the SDR effects image buffer 126 becomes a given pixel of the edited SDR image 140. When the given pixel of the SDR effects image buffer 126 is fully transparent, a corresponding pixel of the unedited SDR image 116 becomes the given pixel of the edited SDR image 140. When the given pixel of the SDR effects image buffer 126 is semi-transparent, the image overlay module 136 performs standard linear alpha blending on the given pixel of the SDR effects image buffer 126 to generate the given pixel of the edited SDR image 140.

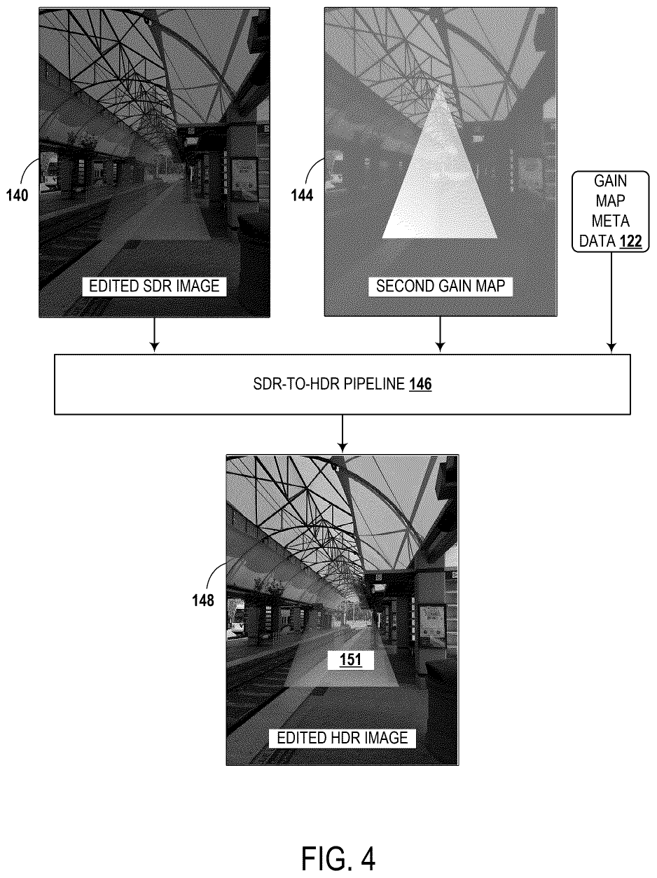

Turning to FIG. 4, the edited SDR image 140, the second gain map 144, and the gain map metadata 122 are received by the SDR-to-HDR pipeline 146 and processed to generate an edited HDR image 148. In the example of FIG. 4, the edited SDR image 140 and the edited HDR image 148 depict a scene on a train platform, and the rendered effect is a transparent triangle floating at the edge of the train platform. The edited HDR image 148 is generated in a format that encodes the second gain map 144 to render the scene on the train platform in a dynamic range that exceeds that of the edited SDR image 140.

Returning to FIG. 1, the edited HDR image 148 may be outputted for rendering on the display 152 and/or encoded by the video encoder 158 to generate and output an encoded video 160 formatted for storage or sharing. A preview generator 154 may also be executed to generate a preview 156 for rendering on the display 152 based on the edited HDR image 148 before a user authorizes the video encoder 158 to generate an encoded video 160 for sharing. For example, a preview 156 may be rendered on the display 152 based on the edited HDR image 148, a user input may be received to authorize the generation of an encoded video stream 160, and responsive to receiving the user input, the video encoder 158 generates the encoded video stream 160 for sharing.

Additionally or alternatively, the effects rendering module 124 may be configured to render at least one overlay image on an HDR effects image buffer 130, as indicated by the dotted arrows in FIG. 1. These overlay images may be rendered onto an empty HDR effects image buffer 130, such that only the pixels that are directly affected by the effects are modified, and pixels where no effects are present remain fully transparent pixels. When the overlay images are images such as stickers and emojis, the boundaries of the images are smaller than the boundaries of the HDR image 110. An inverse tone mapping function 129, which is the inverse function of the tone mapping function 128, may subsequently be applied to the HDR effects image buffer 130 to generate the SDR effects image buffer 126. The inverse tone mapping function 129 is configured to determine an adjustment factor of a given pixel of the HDR effects image buffer 130 based on a peak luminance of the display 152, and scale each color component of the given pixel based on the adjustment factor. The generated SDR effects image buffer 126 may then be used by the image overlay module 136 to generate the edited SDR image 140, and also used by the gain map generator 132 along with the HDR effects image buffer 130 to generate the effects gain map 134.

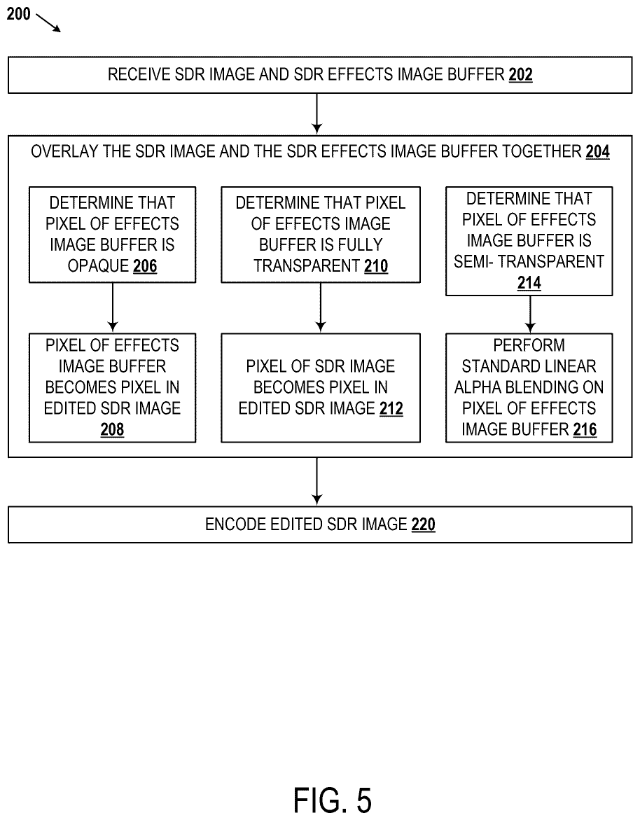

FIG. 5 shows a process flow diagram of an example method 200 for overlaying an unedited SDR image and an SDR effects image buffer together. The example method 200 may be executed by the image overlay module 136 of FIG. 1 to overlay the SDR image 116 and the SDR effects image buffer 126 together to generate an edited SDR image 140. The example method 200 includes, at step 202, receiving an SDR image and an SDR effects image buffer. The HDR image can be received in various ways and from various sources, including from a camera configured to capture HDR image or an image importer configured to import the HDR image from various external sources, for example. The example method 200 includes, at step 204, overlaying the SDR image and the SDR effects image buffer together.

Step 204 may include step 206 of determining that a given pixel of the SDR effects image buffer is opaque. For example, step 206 may determine that the given pixel of the SDR effects image buffer has an alpha value of one. Responsive to determining that the given pixel of the SDR effects image buffer is opaque, at step 208, the given pixel of the SDR effects image buffer becomes a given pixel of the edited SDR image.

Step 204 may include step 210 of determining that the given pixel of the SDR effects image buffer is fully transparent. For example, step 210 may determine that the given pixel of the SDR effects image buffer has an alpha value of zero. Responsive to determining that the given pixel of the SDR effects image buffer is fully transparent, a step 212, a corresponding pixel of the unedited SDR image becomes the given pixel of the edited SDR image.

Step 204 may include step 214 of determining that the given pixel of the SDR effects image buffer is semi-transparent. For example, step 214 may determine that the given pixel of the SDR effects image buffer has an alpha value of greater than zero and less than one. Responsive to determining that the given pixel of the SDR effects image buffer is semi-transparent, at step 216, standard linear alpha blending is performed on the given pixel of the SDR effects image buffer to generate the given pixel of the edited SDR image. At step 220, the edited SDR image is encoded to generate the edited SDR image.

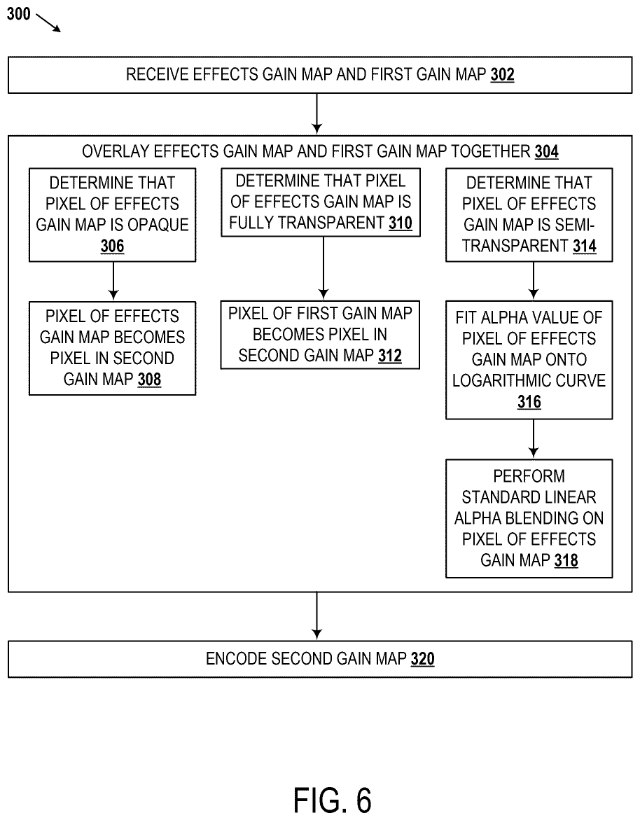

FIG. 6 shows a process flow diagram of an example method 300 for overlaying an effects gain map and a first gain map together. The example method 300 may be executed by the image overlay module 136 of FIG. 1 to overlay the first gain map 120 and the effects gain map 134 together to generate a second gain map 144. The example method 300 includes, at step 302, receiving a first gain map and an effects gain map, and at step 304, overlaying the first gain map and the effects gain map together.

Step 304 may include step 306 of determining that a given pixel of the effects gain map is opaque. For example, step 306 may determine that the given pixel of the effects gain map has an alpha value of one. Responsive to determining that the given pixel of the effects gain map is opaque, at step 308, the given pixel of the effects gain map becomes a given pixel of the second gain map.

Step 304 may include step 310 of determining that the pixel of the effects gain map is fully transparent. For example, step 310 may determine that the pixel of the effects gain map has an alpha value of zero. Responsive to determining that the pixel of the effects gain map is fully transparent, at step 312, a corresponding pixel of the first gain map becomes the pixel of the second gain map.

Step 304 may include step 314 of determining that the given pixel of the effects gain map is semi-transparent. For example, step 314 may determine that the given pixel of the effects gain map has an alpha value of greater than zero and less than one. Responsive to determining that the given pixel of the effects gain map is semi-transparent, at step 316, the alpha value of the given pixel of the effects gain map is fitted onto a logarithmic curve and, at step 318, standard linear alpha blending is performed on the given pixel of the effects gain map to generate the given pixel of the second gain map. At step 320, the second gain map is encoded.

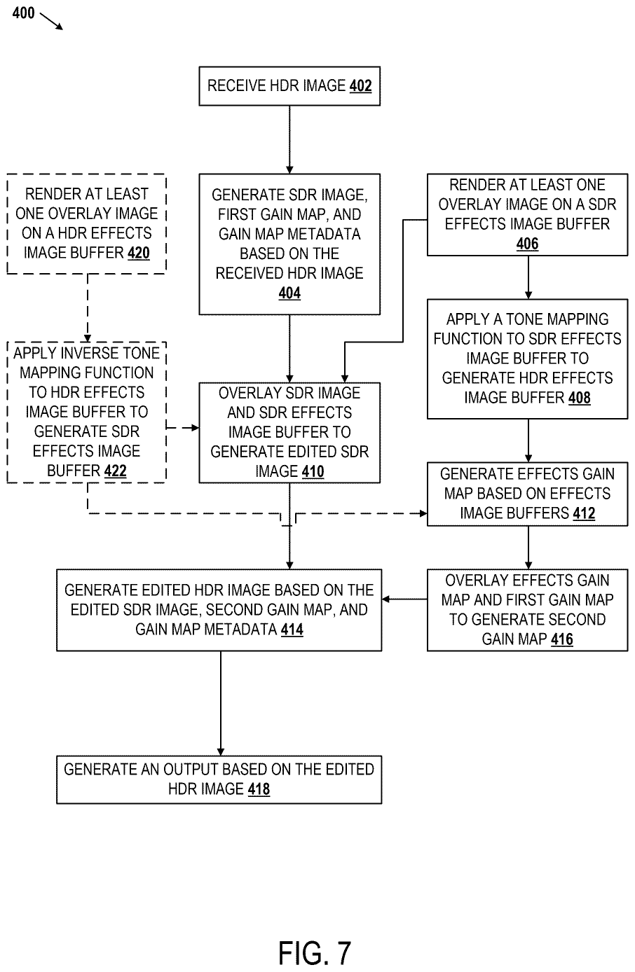

FIG. 7 shows a process flow diagram of an example method 400 for overlaying visual effects on an HDR image. The example method 400 may be executed by the processing circuitry 102 and memory 104 of the computing system 100 of FIG. 1. The example method 400 includes, at step 402, receiving an HDR image. The example method 400 further includes, at step 404, generating a first gain map, gain map metadata, and an SDR image based on the received HDR image.

The example method 400 includes, at step 410, overlaying the SDR image and the SDR effects image buffer to generate an edited SDR image. The example method 400 includes, at step 414, generating an edited HDR image based on the edited SDR image, the second gain map, and the gain map metadata. At step 418, the method 400 includes generating an output based on the edited HDR image.

At step 406, the method 400 includes rendering at least one overlay image to generate an SDR effects image buffer. At step 408, the method 400 includes applying a tone mapping function to the SDR effects image buffer to generate an HDR effects image buffer. At step 412, the method 400 includes generating an effects gain map using the SDR effects image buffer and the HDR effects image buffer. At step 416, the method 400 includes overlaying the effects gain map and the first gain map to generate a second gain map.

Additionally or alternatively, the method 400 may include step 420 of rendering at least one overlay image on an HDR effects image buffer, step 422 of applying an inverse tone mapping function to the HDR effects image buffer to generate the SDR effects image buffer, and step 412 of generating the effects gain map using the SDR effects image buffer and the HDR effects image buffer. The SDR effects image buffer generated in step 422 may be used in step 410 to generate the edited SDR image.

As described throughout herein, by converting an HDR image into SDR and then applying image overlays, users can retain the high-quality image overlay effects originally designed for SDR content while ensuring compatibility with the broader color and dynamic range associated with the HDR format. This approach allows apps and software, which were initially developed for SDR image processing, to be used effectively on HDR content without introducing visual artifacts or distortions, such as oversaturation or desaturation in certain color spaces. Consequently, this system enhances the viewing experience of published HDR images with added image overlay effects, maintaining the integrity of the visual quality of the original HDR images. Furthermore, the quality of photos created with HDR-enabled cameras can be increased to meet high standards of visual fidelity and consistency across a range of devices and platforms.

In some embodiments, the methods and processes described herein may be tied to a computing system of one or more computing devices. In particular, such methods and processes may be implemented as a computer-application program or service, an Application Program Interface (API), a library, and/or other computer-program product. In some embodiments, the methods and processes described herein may be tied to a computing system of one or more computing devices. In particular, such methods and processes may be implemented as a computer-application program or service, an API, a library, and/or other computer-program product.

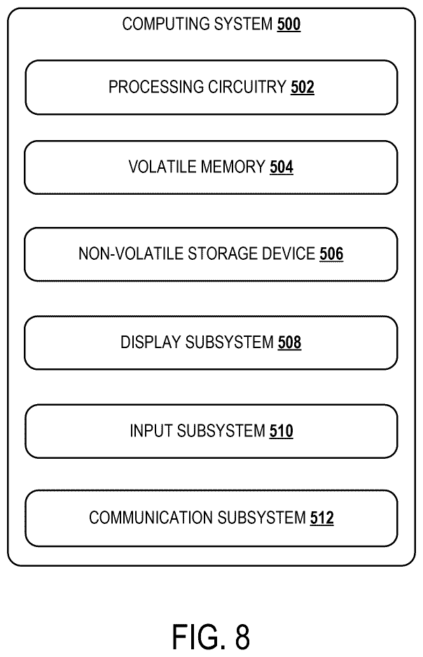

FIG. 8 schematically shows a non-limiting embodiment of a computing system 500 that can enact one or more of the methods and processes described above. Computing system 500 is shown in simplified form. Computing system 500 may embody the computing system 100 described above and illustrated in FIG. 1. Components of computing system 500 may be included in one or more personal computers, server computers, tablet computers, home-entertainment computers, network computing devices, video game devices, mobile computing devices, mobile communication devices (e.g., smartphone), and/or other computing devices, and wearable computing devices such as smart wristwatches and head mounted augmented reality devices.

Computing system 500 includes processing circuitry 502, volatile memory 504, and a non-volatile storage device 506. Computing system 500 may optionally include a display subsystem 508, input subsystem 510, communication subsystem 512, and/or other components not shown in FIG. 8.

Processing circuitry typically includes one or more logic processors, which are physical devices configured to execute instructions. For example, the logic processors may be configured to execute instructions that are part of one or more applications, programs, routines, libraries, objects, components, data structures, or other logical constructs. Such instructions may be implemented to perform a task, implement a data type, transform the state of one or more components, achieve a technical effect, or otherwise arrive at a desired result.

The logic processor may include one or more physical processors configured to execute software instructions. Additionally or alternatively, the logic processor may include one or more hardware logic circuits or firmware devices configured to execute hardware-implemented logic or firmware instructions. Processors of the processing circuitry 502 may be single-core or multi-core, and the instructions executed thereon may be configured for sequential, parallel, and/or distributed processing. Individual components of the processing circuitry optionally may be distributed among two or more separate devices, which may be remotely located and/or configured for coordinated processing. For example, aspects of the computing system disclosed herein may be virtualized and executed by remotely accessible, networked computing devices configured in a cloud-computing configuration. In such a case, these virtualized aspects are run on different physical logic processors of various different machines, it will be understood. These different physical logic processors of the different machines will be understood to be collectively encompassed by processing circuitry 502.

Non-volatile storage device 506 includes one or more physical devices configured to hold instructions executable by the processing circuitry to implement the methods and processes described herein. When such methods and processes are implemented, the state of non-volatile storage device 506 may be transformed—e.g., to hold different data.

Non-volatile storage device 506 may include physical devices that are removable and/or built in. Non-volatile storage device 506 may include optical memory, semiconductor memory, and/or magnetic memory, or other mass storage device technology. Non-volatile storage device 506 may include nonvolatile, dynamic, static, read/write, read-only, sequential-access, location-addressable, file-addressable, and/or content-addressable devices. It will be appreciated that non-volatile storage device 506 is configured to hold instructions even when power is cut to the non-volatile storage device 506.

Volatile memory 504 may include physical devices that include random access memory. Volatile memory 504 is typically utilized by processing circuitry 502 to temporarily store information during processing of software instructions. It will be appreciated that volatile memory 504 typically does not continue to store instructions when power is cut to the volatile memory 504.

Aspects of processing circuitry 502, volatile memory 504, and non-volatile storage device 506 may be integrated together into one or more hardware-logic components. Such hardware-logic components may include field-programmable gate arrays (FPGAs), program- and application-specific integrated circuits (PASIC/ASICs), program- and application-specific standard products (PSSP/ASSPs), system-on-a-chip (SOC), and complex programmable logic devices (CPLDs), for example.

The terms “module,” “program,” and “engine” may be used to describe an aspect of computing system 500 typically implemented in software by a processor to perform a particular function using portions of volatile memory, which function involves transformative processing that specially configures the processor to perform the function. Thus, a module, program, or engine may be instantiated via processing circuitry 502 executing instructions held by non-volatile storage device 506, using portions of volatile memory 504. It will be understood that different modules, programs, and/or engines may be instantiated from the same application, service, code block, object, library, routine, API, function, etc. Likewise, the same module, program, and/or engine may be instantiated by different applications, services, code blocks, objects, routines, APIs, functions, etc. The terms “module,” “program,” and “engine” may encompass individual or groups of executable files, data files, libraries, drivers, scripts, database records, etc.

When included, display subsystem 508 may be used to present a visual representation of data held by non-volatile storage device 506. The visual representation may take the form of a graphical user interface (GUI). As the herein described methods and processes change the data held by the non-volatile storage device, and thus transform the state of the non-volatile storage device, the state of display subsystem 508 may likewise be transformed to visually represent changes in the underlying data. Display subsystem 508 may include one or more display devices utilizing virtually any type of technology. Such display devices may be combined with processing circuitry 502, volatile memory 504, and/or non-volatile storage device 506 in a shared enclosure, or such display devices may be peripheral display devices.

When included, input subsystem 510 may comprise or interface with one or more user-input devices such as a keyboard, mouse, touch screen, camera, or microphone.

When included, communication subsystem 512 may be configured to communicatively couple various computing devices described herein with each other, and with other devices. Communication subsystem 512 may include wired and/or wireless communication devices compatible with one or more different communication protocols. As non-limiting examples, the communication subsystem may be configured for communication via a wired or wireless local- or wide-area network, broadband cellular network, etc. In some embodiments, the communication subsystem may allow computing system 500 to send and/or receive messages to and/or from other devices via a network such as the Internet.

The following paragraphs provide additional description of the subject matter of the present disclosure. One aspect provides a computing system for applying image overlays onto a High Dynamic Range (HDR) image, the computing system comprising processing circuitry and memory storing instructions that, when executed, cause the processing circuitry to receive an HDR image, generate a first gain map and a Standard Dynamic Range (SDR) image based on the received HDR image, render at least one overlay image to generate an SDR effects image buffer and an effects gain map, overlay the effects gain map and the first gain map to generate a second gain map, overlay the SDR image and the SDR effects image buffer to generate an edited SDR image, generate an edited HDR image based on the edited SDR image and the second gain map, and generate an output based on the edited HDR image.

In this aspect, additionally or alternatively, the processing circuitry may be further caused to render the at least one overlay image on the SDR effects image buffer, apply a tone mapping function to the SDR effects image buffer to generate an HDR effects image buffer, and generate the effects gain map using the SDR effects image buffer and the HDR effects image buffer.

In this aspect, additionally or alternatively, the edited HDR image may be outputted for rendering on a display, and the tone mapping function may be configured to determine an adjustment factor of a given pixel of the SDR effects image buffer based on a peak luminance of the display, and scale each color component of the given pixel based on the adjustment factor.

In this aspect, additionally or alternatively, when the SDR image and the SDR effects image buffer are overlaid together, when a given pixel of the SDR effects image buffer is opaque, the given pixel of the SDR effects image buffer may become a given pixel of the edited SDR image, when the given pixel of the SDR effects image buffer is fully transparent, a corresponding pixel of the SDR image may become the given pixel of the edited SDR image, and when the given pixel of the SDR effects image buffer is semi-transparent, standard linear alpha blending may be performed on the given pixel of the SDR effects image buffer to generate the given pixel of the edited SDR image.

In this aspect, additionally or alternatively, the processing circuitry may be further caused to render the at least one overlay image on an HDR effects image buffer, apply an inverse tone mapping function to the HDR effects image buffer to generate the SDR effects image buffer, and generate the effects gain map using the SDR effects image buffer and the HDR effects image buffer.

In this aspect, additionally or alternatively, the edited HDR image may be outputted for rendering on a display, and the inverse tone mapping function may be configured to determine an adjustment factor of a given pixel of the HDR effects image buffer based on a peak luminance of the display, and scale each color component of the given pixel based on the adjustment factor.

In this aspect, additionally or alternatively, when the effects gain map and the first gain map are overlaid together, when a given pixel of the effects gain map is opaque, the given pixel of the effects gain map may become a given pixel of the second gain map, when the given pixel of the effects gain map is fully transparent, a corresponding pixel of the first gain map may become the given pixel of the second gain map, and when the given pixel of the effects gain map is semi-transparent, an alpha value of the given pixel of the effects gain map may be fitted to a logarithmic curve, and standard linear alpha blending may be further performed on the given pixel of the effects gain map to generate the given pixel of the second gain map.

In this aspect, additionally or alternatively, the at least one overlay image may include at least one of a sticker, an emoji, a virtual prop, text effects, a face mask, an object, or particle effects.

In this aspect, additionally or alternatively, a tone mapping algorithm may be applied to each pixel in the HDR image to further generate gain map metadata.

In this aspect, additionally or alternatively, the gain map metadata may describe a dynamic range and a resolution of the HDR image.

Another aspect provides a computing method for applying image overlays onto a High Dynamic Range (HDR) image, the computing method comprising receiving an HDR image, generating a first gain map and a Standard Dynamic Range (SDR) image based on the received HDR image, rendering at least one overlay image to generate an SDR effects image buffer and an effects gain map, overlaying the effects gain map and the first gain map to generate a second gain map, overlaying the SDR image and the SDR effects image buffer to generate an edited SDR image, generating an edited HDR image based on the edited SDR image and the second gain map, and generating an output based on the edited HDR image.

In this aspect, additionally or alternatively, the computing method may further comprise rendering the at least one overlay image on the SDR effects image buffer, applying a tone mapping function to the SDR effects image buffer to generate an HDR effects image buffer, and generating the effects gain map using the SDR effects image buffer and the HDR effects image buffer.

In this aspect, additionally or alternatively, the edited HDR image may be outputted for rendering on a display, and the tone mapping function may be configured to determine an adjustment factor of a given pixel of the SDR effects image buffer based on a peak luminance of the display, and scale each color component of the given pixel based on the adjustment factor.

In this aspect, additionally or alternatively, when the SDR image and the SDR effects image buffer are overlaid together, when a given pixel of the SDR effects image buffer is opaque, the given pixel of the SDR effects image buffer may become a given pixel of the edited SDR image, when the given pixel of the SDR effects image buffer is fully transparent, a corresponding pixel of the SDR image may become the given pixel of the edited SDR image, and when the given pixel of the SDR effects image buffer is semi-transparent, standard linear alpha blending may be performed on the given pixel of the SDR effects image buffer to generate the given pixel of the edited SDR image.

In this aspect, additionally or alternatively, the computing method may further comprise rendering the at least one overlay image on an HDR effects image buffer, applying an inverse tone mapping function to the HDR effects image buffer to generate the SDR effects image buffer, and generating the effects gain map using the SDR effects image buffer and the HDR effects image buffer.

In this aspect, additionally or alternatively, the edited HDR image may be outputted for rendering on a display, and the inverse tone mapping function may be configured to determine an adjustment factor of a given pixel of the HDR effects image buffer based on a peak luminance of the display, and scale each color component of the given pixel based on the adjustment factor.

In this aspect, additionally or alternatively, when the effects gain map and the first gain map are overlaid together, when a given pixel of the effects gain map is opaque, the given pixel of the effects gain map may become a given pixel of the second gain map, when the given pixel of the effects gain map is fully transparent, a corresponding pixel of the first gain map may become the given pixel of the second gain map, and when the given pixel of the effects gain map is semi-transparent, an alpha value of the given pixel of the effects gain map may be fitted to a logarithmic curve, and standard linear alpha blending may be further performed on the given pixel of the effects gain map to generate the given pixel of the second gain map.

In this aspect, additionally or alternatively, the at least one overlay image includes at least one of a sticker, an emoji, a virtual prop, text effects, a face mask, an object, or particle effects.

In this aspect, additionally or alternatively, a tone mapping algorithm may be applied to each pixel in the HDR image to further generate gain map metadata.

Another aspect provides a computing system for applying image overlays onto a High Dynamic Range (HDR) image, the computing system comprising processing circuitry and memory storing instructions that, when executed, cause the processing circuitry to receive the HDR image, generate a first gain map and a Standard Dynamic Range (SDR) image based on the received HDR image, render at least one overlay image to generate an SDR effects image buffer, use a tone mapping function to generate an effects gain map, overlay the effects gain map and the first gain map to generate a second gain map, overlay the SDR image and the SDR effects image buffer to generate an edited SDR image, generate an edited HDR image based on the edited SDR image and the second gain map, and output the edited HDR image for rendering on a display, wherein the tone mapping function is configured to determine an adjustment factor of a given pixel of the SDR effects image buffer based on a peak luminance of the display, and scale each color component of the given pixel based on the adjustment factor.

It will be understood that the configurations and/or approaches described herein are exemplary in nature, and that these specific embodiments or examples are not to be considered in a limiting sense, because numerous variations are possible. The specific routines or methods described herein may represent one or more of any number of processing strategies. As such, various acts illustrated and/or described may be performed in the sequence illustrated and/or described, in other sequences, in parallel, or omitted. Likewise, the order of the above-described processes may be changed.

The subject matter of the present disclosure includes all novel and non-obvious combinations and sub-combinations of the various processes, systems and configurations, and other features, functions, acts, and/or properties disclosed herein, as well as any and all equivalents thereof.

1. A computing system for applying image overlays onto a High Dynamic Range (HDR) image, the computing system comprising:
processing circuitry and memory storing instructions that, when executed, cause the processing circuitry to:
receive an HDR image;
generate a first gain map and a Standard Dynamic Range (SDR) image based on the received HDR image;
render at least one overlay image to generate an SDR effects image buffer and an effects gain map;
overlay the effects gain map and the first gain map to generate a second gain map;
overlay the SDR image and the SDR effects image buffer to generate an edited SDR image;
generate an edited HDR image based on the edited SDR image and the second gain map; and
generate an output based on the edited HDR image.

2. The computing system of claim 1, wherein the processing circuitry is further caused to:
render the at least one overlay image on the SDR effects image buffer;
apply a tone mapping function to the SDR effects image buffer to generate an HDR effects image buffer; and
generate the effects gain map using the SDR effects image buffer and the HDR effects image buffer.

3. The computing system of claim 2, wherein
the edited HDR image is outputted for rendering on a display; and
the tone mapping function is configured to determine an adjustment factor of a given pixel of the SDR effects image buffer based on a peak luminance of the display, and scale each color component of the given pixel based on the adjustment factor.

4. The computing system of claim 1, wherein when the SDR image and the SDR effects image buffer are overlaid together,
when a given pixel of the SDR effects image buffer is opaque, the given pixel of the SDR effects image buffer becomes a given pixel of the edited SDR image;
when the given pixel of the SDR effects image buffer is fully transparent, a corresponding pixel of the SDR image becomes the given pixel of the edited SDR image; and
when the given pixel of the SDR effects image buffer is semi-transparent, standard linear alpha blending is performed on the given pixel of the SDR effects image buffer to generate the given pixel of the edited SDR image.

5. The computing system of claim 1, wherein the processing circuitry is further caused to:
render the at least one overlay image on an HDR effects image buffer;
apply an inverse tone mapping function to the HDR effects image buffer to generate the SDR effects image buffer; and
generate the effects gain map using the SDR effects image buffer and the HDR effects image buffer.

6. The computing system of claim 5, wherein
the edited HDR image is outputted for rendering on a display; and
the inverse tone mapping function is configured to determine an adjustment factor of a given pixel of the HDR effects image buffer based on a peak luminance of the display, and scale each color component of the given pixel based on the adjustment factor.

7. The computing system of claim 1, wherein when the effects gain map and the first gain map are overlaid together,
when a given pixel of the effects gain map is opaque, the given pixel of the effects gain map becomes a given pixel of the second gain map;
when the given pixel of the effects gain map is fully transparent, a corresponding pixel of the first gain map becomes the given pixel of the second gain map; and
when the given pixel of the effects gain map is semi-transparent, an alpha value of the given pixel of the effects gain map is fitted to a logarithmic curve, and standard linear alpha blending is further performed on the given pixel of the effects gain map to generate the given pixel of the second gain map.

8. The computing system of claim 1, wherein the at least one overlay image includes at least one of a sticker, an emoji, a virtual prop, text effects, a face mask, an object, or particle effects.

9. The computing system of claim 1, wherein
a tone mapping algorithm is applied to each pixel in the HDR image to further generate gain map metadata.

10. The computing system of claim 9, wherein the gain map metadata describes a dynamic range and a resolution of the HDR image.

11. A computing method for applying image overlays onto a High Dynamic Range (HDR) image, the computing method comprising:
receiving an HDR image;
generating a first gain map and a Standard Dynamic Range (SDR) image based on the received HDR image;
rendering at least one overlay image to generate an SDR effects image buffer and an effects gain map;
overlaying the effects gain map and the first gain map to generate a second gain map;
overlaying the SDR image and the SDR effects image buffer to generate an edited SDR image;
generating an edited HDR image based on the edited SDR image and the second gain map; and
generating an output based on the edited HDR image.

12. The computing method of claim 11, further comprising:
rendering the at least one overlay image on the SDR effects image buffer;
applying a tone mapping function to the SDR effects image buffer to generate an HDR effects image buffer; and
generating the effects gain map using the SDR effects image buffer and the HDR effects image buffer.

13. The computing method of claim 12, wherein
the edited HDR image is outputted for rendering on a display; and
the tone mapping function is configured to determine an adjustment factor of a given pixel of the SDR effects image buffer based on a peak luminance of the display, and scale each color component of the given pixel based on the adjustment factor.

14. The computing method of claim 11, wherein when the SDR image and the SDR effects image buffer are overlaid together,
when a given pixel of the SDR effects image buffer is opaque, the given pixel of the SDR effects image buffer becomes a given pixel of the edited SDR image;
when the given pixel of the SDR effects image buffer is fully transparent, a corresponding pixel of the SDR image becomes the given pixel of the edited SDR image; and
when the given pixel of the SDR effects image buffer is semi-transparent, standard linear alpha blending is performed on the given pixel of the SDR effects image buffer to generate the given pixel of the edited SDR image.

15. The computing method of claim 11, further comprising:
rendering the at least one overlay image on an HDR effects image buffer;
applying an inverse tone mapping function to the HDR effects image buffer to generate the SDR effects image buffer; and
generating the effects gain map using the SDR effects image buffer and the HDR effects image buffer.

16. The computing method of claim 15, wherein
the edited HDR image is outputted for rendering on a display; and
the inverse tone mapping function is configured to determine an adjustment factor of a given pixel of the HDR effects image buffer based on a peak luminance of the display, and scale each color component of the given pixel based on the adjustment factor.

17. The computing method of claim 11, wherein when the effects gain map and the first gain map are overlaid together,
when a given pixel of the effects gain map is opaque, the given pixel of the effects gain map becomes a given pixel of the second gain map;
when the given pixel of the effects gain map is fully transparent, a corresponding pixel of the first gain map becomes the given pixel of the second gain map; and
when the given pixel of the effects gain map is semi-transparent, an alpha value of the given pixel of the effects gain map is fitted to a logarithmic curve, and standard linear alpha blending is further performed on the given pixel of the effects gain map to generate the given pixel of the second gain map.

18. The computing method of claim 11, wherein the at least one overlay image includes at least one of a sticker, an emoji, a virtual prop, text effects, a face mask, an object, or particle effects.

19. The computing method of claim 11, wherein
a tone mapping algorithm is applied to each pixel in the HDR image to further generate gain map metadata.

20. A computing system for applying image overlays onto a High Dynamic Range (HDR) image, the computing system comprising:
processing circuitry and memory storing instructions that, when executed, cause the processing circuitry to:
receive the HDR image;
generate a first gain map and a Standard Dynamic Range (SDR) image based on the received HDR image;
render at least one overlay image to generate an SDR effects image buffer;
use a tone mapping function to generate an effects gain map;
overlay the effects gain map and the first gain map to generate a second gain map;
overlay the SDR image and the SDR effects image buffer to generate an edited SDR image;
generate an edited HDR image based on the edited SDR image and the second gain map; and
output the edited HDR image for rendering on a display, wherein
the tone mapping function is configured to determine an adjustment factor of a given pixel of the SDR effects image buffer based on a peak luminance of the display, and scale each color component of the given pixel based on the adjustment factor.
